(19) United States
(12) Patent Application Publication
(10) Pub. No.: US 2004/0114548 A1
(43) Pub. Date: Jun. 17, 2004

(54) Polarization division multiplex access system

(76) Inventors: Jyoti Prasad, Gistrup (DK); Dikshitulu Kalluri, Lowell, MA (US); Veronique Farserotu, Neuchatel (CH); Nunta Vanichsetakul, Wayne, NJ (US)

Correspondence Address: CANTOR COLBURN, LLP, 55 GRIFFIN ROAD SOUTH, BLOOMFIELD, CT, 06002

(21) Appl. No.: 10/470,182

(22) PCT Filed: Jan. 23, 2001
(86) PCT No.: PCT/DK01/00050

(51) Int. Cl. H04B 7/204

(52) U.S. Cl. 370/319

(57) ABSTRACT

A method of and a system for wireless communication comprising at least one communication channel whereupon a multiplex technique is employed for the communication and whereby a multiplexing technique using wave polarization (PDMA—Polarization Division Multiplex Access) is utilized. By the invention is achieved a novel multiplexaccess technique called a Polarization Division Multiplex Access (PDMA). The invention will give the advantage of a new dimension and revolution in the field of present and future wireless communications by increasing the capacity of a system in terms of a higher data rate, less frequency banwidth requirement increase in the number of simultaneous users enhanced coverage area, lower the interference, noise reduction, and boosting the power level. These advantages may all be achieved by the PDMA technique according to the invention. PDMA is an answer to the challenges encountered by cellular systems, wireless local area network and wireless computing to achieve the future objectives.

### FIELD OF THE INVENTION

The invention relates to a method of wireless communication according to claim 1, a system for wireless communication according to claim 8, a transmitter and a receiver according to claim 14 and 16, respectively, for use in connection with a method and a system for wireless communication, and uses thereof.

### BACKGROUND OF THE INVENTION

Mobile radio communications systems play an important role in communications and in the international trend towards information society. These systems have been deployed successfully in different regions of the world since about 1980 to extend telephone services to mobile users. The worldwide dominating second generation standard is the GSM system (Global Standard for Mobile Communication), which was deployed since 1991. Its main original objective was to support voice telephony and international roaming. In parallel to GSM other digital systems have been developed as the CDMA-based IS-95 and TDMA-based systems as IS-54, ANSI- 136 and PDC.

The GSM system is being further developed based on its big worldwide footprint to more data services by techniques such as High Speed Circuit Switched Data (HSCSD)., General Packet Radio Service (GPRS) and the EDGE system (Enhanced Data rates for GSM evolution). Despite these steps in the evolution of second generation systems third generation mobile radio systems (IMT-2000 in ITU, UMTS in Europe) are currently being standardised worldwide. Their main goals are to support broadband data services and mobile multimedia up to 2 Mbps by a wideband radio interface, international roaming for circuit—switched and packet-oriented—services. These sytems aim to integrate different second generation cellular and cordless services. IMT-2000 supports time division duplex (TDD) and frequency division duplex (FDD) to enable asymmetric and symmetric data services in a spectrum efficient way. At the end of 1999ITU-R approved the specifications of the IM-2000 radio interfaces, which are part of the IMT-2000 family.

The megatrend mobile communications and the rapid growth of the Internet dominate communications in the last year. The new megatrend is the integration of mobile communications and the Internet to mobile Internet applications. With the evolution of the second and third generation systems more advanced data and multimedia services are becoming available in addition to mobile telephony, which make this new megatrend happen. However, the development of mobile communications is determined by economic and technical trends and in the future mainly by application requirements. These trends and requirements are affecting the vision of future systems beyond third generation.

The spectacular growth of video, voice and data communication over the Internet, and the equally rapid pervasion of mobile telephony, justify great expectations for mobile multimedia. Research and development are taking place all over the world to define the next generation of wireless broadband multimedia communications systems (WBMCS) that may create the “global information village”. FIG. 1 illustrates the basic concept scales ranging from global to picocellular size. As we know, the demand for wireless (mobile) communications and Internet/multimedia communications is growing exponentially. Therefore, it is imperative that both wireless and Internet/multimedia should be brought together. Thus, in the near future, wireless Internet Protocol (IP) and wireless asynchronous transfer mode (ATM) will play an important role in the development of WBMCS.

While present communications systems are primarily designed for one specific application, such as speech on a mobile telephone or high-rate data in a wireless local area network (LAN), the next generation WBMCS will integrate various functions applications. WBMCS is expected to provide its users with customers premises services that have information rates exceeding 2 Mbps Supporting such large data rates with sufficient robustness to radio channel impairments, requires careful choosing of modulation technique. The most suitable modulation choice seems to be orthogonal frequency division multiplexing (OFDM).

The theme of WBMCS is to provide its users a means of radio access to broadband services supported on customers premises network or offered directly by public fixed networks.

Growth of data, voice and video communication and in particular growth of data, voice and video communication over the Internet and the rapid pervasion of mobile telecommunication has created a demand for increasing communication channel capacity and higher data rate.

WBMCS is currently under investigation in North America, Europe, and Japan in the microwave and millimeter-wave bands to accommodate the necessary bandwidth. The research in the field of WBMCS has drawn much attention because of the increasing role of multimedia and computer applications in communications. There is a major thrust in three areas: (1) microwave and millimeter-wave bands for fixed access in outdoor, public commercial networks, (2) evolution of WLAN for inbuilding systems, and (3) use of LAN technology outdoors rather than indoors. In short, WBMCS will provide novel multimedia mobile communications services, also related to wireless customer network (WCPN) and wireless local loop (WLL).

To implement the wireless broadband communication systems, the following challenges must be considered:

Frequency allocation and selection;

Channel characterization;

Application and environment recognition, including health issues;

Technology development;

Air interface multiple access techniques;

Protocols and networks; and

Systems development with efficient modulation, coding and smart antenna techniques.

The object of the invention is to provide a communication method and a communication system, by means of which the above-mentioned challenges may be met. These and other objects are achieved by the invention.

### SUMMARY OF THE INVENTION

The invention relates to a method of wireless communication comprising at least one communication channel whereupon a multiplex technique is employed for the communication and whereby a multiplexing technique using wave polarization (PDMA—Polarization Division Multiplex Access) is utilized.

Hereby it is achieved that in relation to prior art techniques a higher rate of communication may be achieved for a given communication channel and that a higher rate of clarity may be achieved.

The PDMA technique solves the most of the challenges encountered in the development of wireless broadband communication systems. In addition, it proves a boon for the second generation systems namely GSM, PDC, IS 54/136, IS 95, enhanced second generation cellular systems GPRS, EDGE, third generation cellular systems IMT-2000/UMTS, as well as wireless local area networks (WLANs).

By the invention is achieved a novel multiplexaccess technique called a Polarization Division Multiplex Access (PDMA). The invention will bring a new dimension and revolution in the field of present and future wireless communications by increasing the capacity of a system in terms of a higher data rate, less frequency bandwidth requirement, increase in the number of simultaneous users, enhanced coverage area, lower the interference, noise reduction, and boosting the power level. These advantages may all be achieved by the PDMA technique according to the invention. PDMA is an answer to the challenges encountered by cellular systems, wireless local area network, and wireless computing to achieve the future objectives.

Preferably as stated in claim 2, the method may involve a polarization using at least two different polarization values.

Advantageously as stated in claim 3 said at least two different polarization values may be substantially orthogonal.

When as stated in claim 4 said at least two polarization values are a substantially left-hand-circular polarization and a substantially right-hand-circular polarization, a preferred embodiment is achieved, whereby signals may be polarized and depolarized in a practical manner.

Similarly, when as stated in claim 5, said at least two polarization values are a substantially vertical polarization and a substantially horizontal polarization, said signals may be polarized and depolarized in a further practical manner.

Advantageously, as stated in claim 6, a signal transmitted on said at least one communication channel may be subjected to a polarization sequence, whereby an improved clarity of transmitted/received communication may be achieved and whereby multiplexing may be achieved in an advantageous manner.

Preferably as stated in claim 7, said polarization sequence may correspond to a sequence code, whereby a code may be dedicated to a number of persons/addresses/receivers and/or objectives, whereby a secure and/or dedicated communication may be achieved.

The invention further relates to a system for wireless communication comprising at least one communication channel whereupon a multiplex technique is employed for the communication, wherein said system comprises means for transmitting and/or receiving wireless communication signals, said signals having at least two different values of polarization.

Hereby it is achieved that in relation to prior art techniques a higher rate of communication may be achieved for a given communication channel and that a higher rate of clarity may be achieved by the system.

The PDMA technique used by the system solves the most of the challenges encountered in the development of wireless broadband communication systems. In addition, it proves a boon for the second generation systems namely GSM, PDC, IS 54/136, IS 95, enhanced second generation cellular systems GPRS, EDGE, third generation cellular systems IMT-2000/UMTS, as well as wireless local area networks (WLANs).

An advantageous embodiment of the system is achieved when as stated in claim 9 said at least two different polarization values are substantially orthogonal.

In a preferred embodiment as stated in claim 10 said at least two different polarization values are a substantially left-hand-circular polarization and a substantially right-hand-circular polarization.

In a further preferred embodiment as stated in claim 11 said at least two different polarization values are a substantially vertical polarization and a substantially horizontal polarization.

When as stated in claim 12 the system comprises means for introducing a polarization sequence to a signal to be transmitted, preferably in the form of a sequence code and/or for depolarizing a received signal, a system having an improved clarity of transmitted/received communication may be achieved and multiplexing may be achieved in an advantageous manner. Further, when a sequence code is utilized, a secure and/or dedicated communication may be achieved.

Advantageously, as stated in claim 13, the system may comprise antenna and/or waveguide means for transmitting and/or receiving communication signals, said means being capable of transmitting and/or receiving communication signals with at least two different values of polarization.

Further, the invention relates to a transmitter for use in connection with method according to one or more of claims 1-7 and/or in connection with system according to one or more of claims 8-13, wherein said transmitter comprises at least two antenna and/or waveguide means for transmitting signals with at least two different values of polarization.

Advantageously, as stated in claim 15, the transmitter comprises coding means for introducing a coding sequence to an input signal to be transmitted.

Similarly, the invention relates to a receiver for use in connection with method according to one or more of claims 1-7 and/or in connection with system according to one or more of claims 8-13, wherein said receiver comprises at least two antenna and/or waveguide means for receiving signals with at least two different values of polarization.

Preferably, as stated in claim 17, the receiver may comprise decoding means for decoding a received signal in accordance with a coding sequence.

The invention also relates to the use of a method according to one or more of claims 1-7, a system according to one or more of claims 8-13, a transmitter according to claim 14 or 15 and/or a receiver according to claim 16 or 17 in connection with cellular communication systems. Hereby it is achieved that the cell coverage may be expanded, the communication rate may be increased and/or that the intercell interference may be reduced, as a frequency used in one cell may be re-used in an adjacent cell.

Finally, the invention relates to the use of a method according to one or more of claims 1-7, a system according to one or more of claims 8-13, a transmitter according to claim 14 or 15 and/or a receiver according to claim 16 or 17 in connection with secure communication systems.

### THE FIGURES

The invention will be described below with reference to the drawings of which

FIG. 1 illustrates the field of application of the invention,

FIG. 2 shows a system according to an embodiment of the invention, and

FIG. 3 shows a block diagram of transmitter and receiver circuitry according to a further embodiment of the invention.

### DETAILED DESCRIPTION

The invention relates to a novel multiplexaccess technique called a Polarization Division Multiplex Access (PDMA). PDMA will bring a new dimension and revolution in the field of present and future wireless communications by increasing the capacity of a system in terms of higher data rate, less frequency bandwidth requirement, increase in the number of simultaneous users, enhanced coverage area, lower the interference, noise reduction, and boosting the power level. These objects all can be achieved by the PDMA technique. PDMA is an answer to the challenges encountered by cellular systems, wireless local area network, and wireless computing to achieve the future objectives.

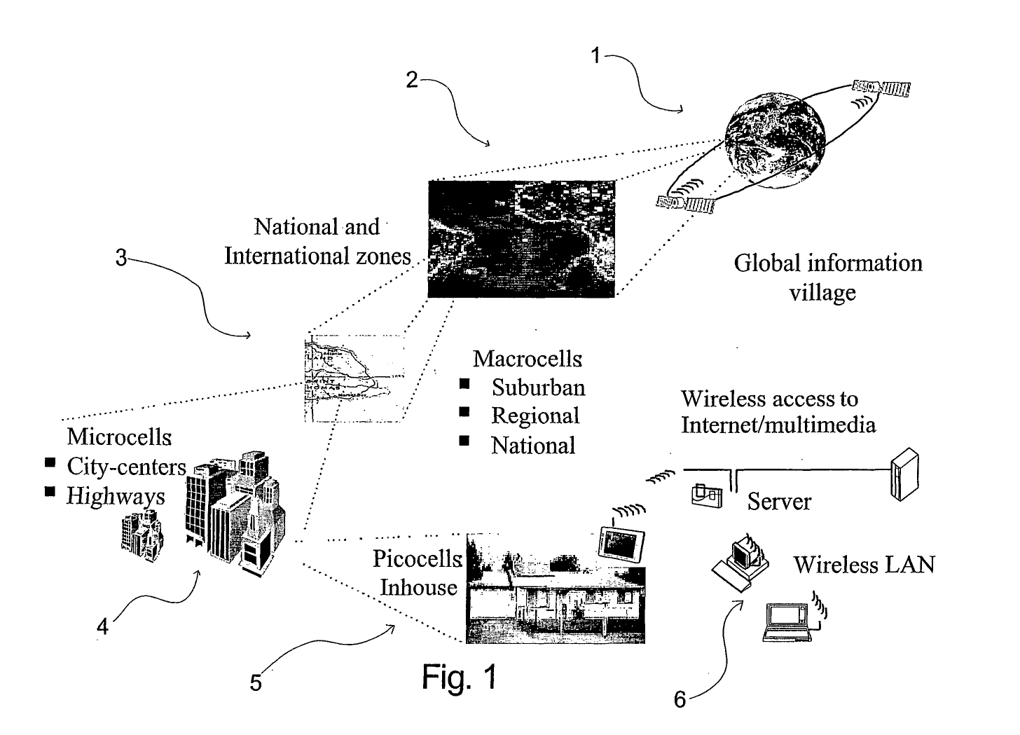

FIG. 1 illustrates the basic concept scales ranging from global to picocellular size, e.g. from global satellite communication systems 1, from communication systems 2 covering national and international zones, communication systems 3 covering macrocells such as suburban, regional and/or national zones, to microcells 4 covering city-center zones, highway zones etc, to picocells 5 such as in-house zones and to wireless local area networks 6 (LAN). Methods and/or systems according to the invention may be utilized in all of the zones and/or in combinations of such zones.

Polarization Division Multiplex Access, PDMA, uses polarization sequence to electromagnetic waves to multiplex communication channel.

The electromagnetic wave from a transmitter alternates between different polarizations, e.g. between left-hand-circular and right-hand-circular polarizations. The intended receiver, knowing the predefined sequence of alternations, switches the antenna/waveguide front-end following the predefined polarization sequence. In so doing, the intended receiver rakes in the full gain from the antenna/waveguide front-end.

For other receivers, not knowing or having a different alternation polarization sequence, the gain of antenna/waveguide front-end is denied.

This ability, to selective deny the front-end gain to all receivers but the intended one, provides the multiplex. Multiple users different polarization sequences share the same channel.

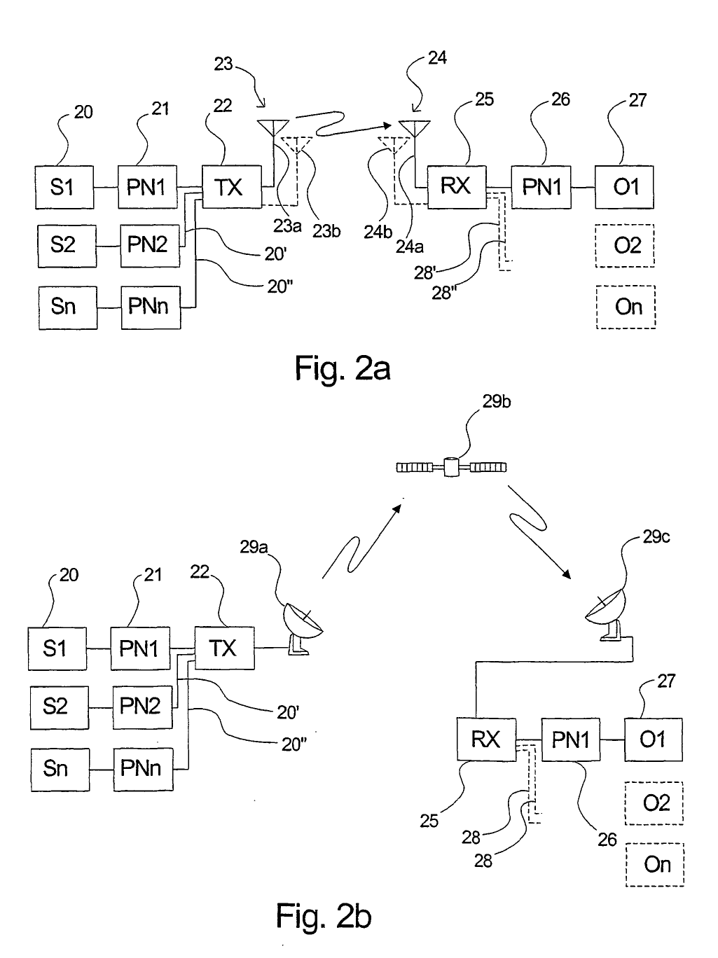

In FIG. 2a a block diagram illustrates an embodiment of the invention in general. An input signal 20 from a source S1 comprising input data such as voice, video or other data is led to a coding block 21, in which the input data is modulated or coded according to a code PN1 dedicated to the input signal source S1. The code PN1 indicates a polarization sequence which will be transferred to the signal to be transmitted. The actual coding and polarization process may be performed in a number of ways, as it will be explained below.

The signal, which has been coded with a polarization sequence, is led to a transmitter circuitry (TX) 22, wherein the signal is modulated according to the specific transmitting means e.g. modulated into a radio frequency signal. Further, means is included in the transmitting circuitry block 22 to achieve that part of the signal with a specific polarization is led to antenna means with such specific polarization means. The antenna means for transmitting the signal, e.g. a radio frequency signal or a microwave signal, is in general denoted 23, and it will be understood that these means comprises means for transmitting signals with different polarization, for example as illustrated a first 23a and a second antenna means 23b having different polarization, for example orthogonal polarizations such as left-right polarizations, horizontal-vertical polarizations etc.

The transmitted signal is received by antenna means generally denoted 24, which antenna means includes means for receiving signals with specific different polarization such as for example as illustrated a first 24a and a second 24b antenna means having different polarization, for example orthogonal polarizations such as left-right polarizations, horizontal-vertical polarizations etc. The received signal is led to a receiving circuitry 25, wherein the signal is demodulated. This signal is led to a decoding block 26, wherein the signal is decoded according to the dedicated code PN1. The decoding block will prevent signals with other coding sequences from being led further on and will decode the signal, whereby an output signal O1 will be led to the output port 27. This output signal O1 will correspond to the input signal S1.

As illustrated the transmitting circuitry may receive inputs, e.g. 20′ and 20″, from other sources, e.g. S2-Sn. Codes, e.g. PN2 and PNn, dedicated to each of these sources are utilized to transfer a polarization code onto the signals as explained above. When the signal transmitted by wireless means is received by the antenna means 24 and the receiving circuitry 25, the involved signals will be decoded according to the dedicated codes, e.g. PN2-PNn, corresponding to the decoding of the signal according to the code PN1 as explained above and by use of decoding blocks corresponding to the decoding block 26. The signal 28 will thus be led to dedicated decoding blocks, wherefrom decoded signals, e.g. O1-On, corresponding to the input signals S1-Sn, will be led to output ports 27.

As illustrated in FIG. 2b, the wireless transmission may be performed by other means than by ordinarily used antenna and radio frequency system, for example by satellite systems. The same reference signs as in FIG. 2a denote means in FIG. 2b, which corresponds to similar means as in FIG. 2a. As illustrated the signal from the transmitter circuitry 22 is transmitted via a satellite dish antenna 29a to a satellite 29b, wherefrom the signal is transmitted to a satellite dish antenna 29c. It will be evident to a skilled person that other means of wireless communication using electromagnetic propagation may be used and that combinations of such communication means may be utilized. Similarly it will be clear that other communication links, such as for example wired communication, may be used as part of the communication route in connection with the described system. Further it will be obvious that a global web such as the Internet may be part of the communication system and that the system may be used in connection with cellular systems such as mobile phone systems.

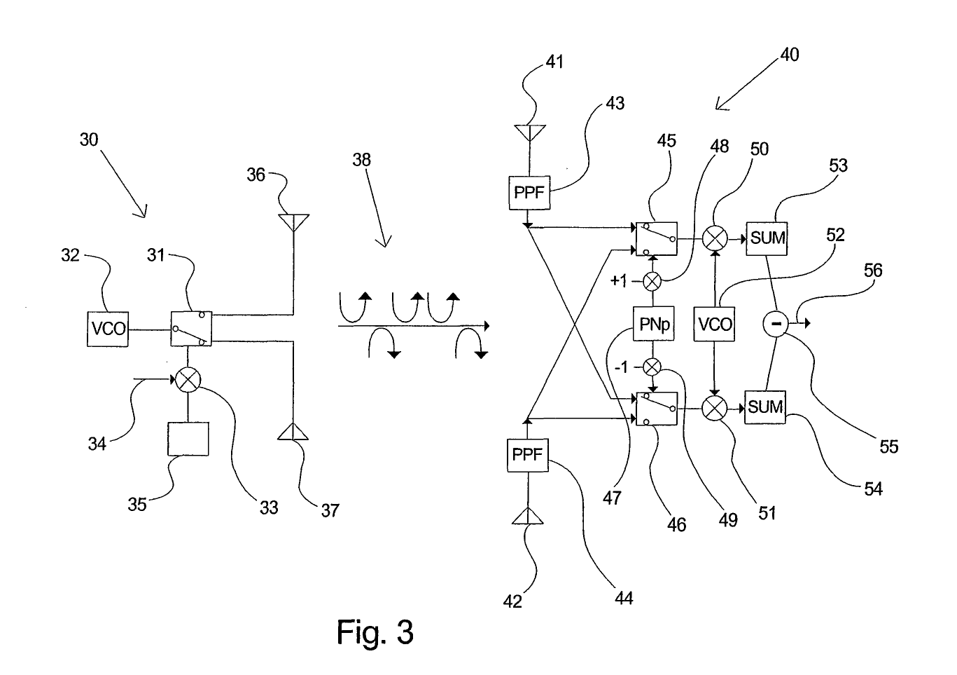

An embodiment of a system according to the invention is shown in FIG. 3 in greater detail. This embodiments comprises a transmitting part generally designated 30 and a receiving part generally designated 40.

The transmitting part 30 comprises a switching circuit 31 which receives an input from an oscillator (VCO) 32 and an input from a multiplier 33. The oscillator 32 serves to provide the radio frequency signal and the multiplier 33 combines the input signal 34, e.g. the data, voice or video signal, with the polarization code PNp provided by block 35. The polarization code will in the described embodiment indicate a sequence of polarization, alternating between to states of polarization, e.g. a left-hand-circular polarization (L) and a right-hand-circular polarization (R), a horizontal polarization and a vertical polarization etc. The signal from the multiplier 33 will bring the switching circuit 31 to direct the signal to either e.g. a left-hand-polarized antenna 36 or a right-hand-polarized antenna 37.

Thus, the data will be transmitted in a signal comprising a number of differently polarized electromagnetic signals 38, wherein the sequence corresponds to the input signal 34 coded by the polarization code PNp.

The signals 38 are received by antenna means 41 and 42, which are correspondingly polarized. The antenna means 41 will thus receive signals with a first polarization with full gain while the antenna means 42 will receive signals with a second polarization with full gain. Polarization filters PPF 43 and 44, respectively, will ensure that the polarization waves goes through and are received by switching circuits 45 and 46, respectively.

The polarization filters, PPF 43 and 44 ensure that the circular polarization waves goes through. This polarization filter may be an integrated part of a circular polarization antenna.

The switching circuits 45 and 46 are controlled by the polarization code PNp provided by block 47 via multipliers 48 and 49, and the output signals from the switching circuits 45 and 46 are by means of multipliers 50 and 51, which provides a demodulation by means of a voltage controlled oscillator 52, led to summing circuits 53 and 54, respectively. Output signals from these are led to a combining circuit 55, the output from which constitutes the resulting data output signal 56, corresponding to the input data signal 34.

The utility of PDMA architecture, as depicted in FIG. 3, will be illustrated in further detail by the following three examples:

### EXAMPLE 1

Simple Transmission

| Transmitter | |
|---|---|
| Data | 1 |
| PN Code | RLLR |
| Reciever | |
| R-Antenna | 1001 |
| L-Antenna | 0110 |
| Upper PN | RLLR |
| Upper Channel | 1111 |
| Lower Channel | 0000 |
| Lower PN | LRRL |
| Sum/4 = 1 | |
| — | =1 (Received Data) |
| — | Sum/4 = 0 |
| Received data | 1 |

### EXAMPLE 2

Transmission with a Fixed Noise in R-Polarization

| Transmitter | |
|---|---|
| Data | 1 |
| PN Code | RLLR |
| Noise Source (in R) | 1111 |
| Received | |
| R-Antenna | 1001 + 1111 |
| L-Antenna | 0110 + 0000 |
| Upper PN | RLLR |
| Upper Channel | 1111 + 1001 |
| Lower Channel | 0000 + 0110 |
| Lower PN | LRRL |
| Sum/4 = 1.5 | |
| — | =1 (Received data) |
| Sum/4 = 0.5 | |
| Received Data | 1 |

### EXAMPLE 3

Transmission with Noise plus Two Interference Sources

| Transmitter | |
|---|---|
| Data | 1 |
| PN Code | RLLR |
| Noise (in R) | 1111 |
| Other Trans - A | |
| Data | 1 |
| PN Code | RRLL |
| Other Trans-B | |
| Data | −1 |
| PN Code | RLRL |
| Receiver | |
| R-Antenna | 1001 + 1111 + 1100 + 0101 |
| L-Antenna | 0110 + 0000 + 0011 + 1010 |
| Upper PN | RLLR |
| Upper Channel | 1111 + 1001 + 1010 + 0011 |
| Lower Channel | 0000 + 0110 + 0101 + 1100 |
| Lower PN | LRRL |
| Sum/4 + 2.5 | |
| — | +1 |
| Sum/4 = 1.5 | |
| Received Data | 1 |

The existing non-polarization communications will appear as a fixed polarization “noise” to a PDMA receiver, as illustrated in Example-2.

Assuming that the PDMA has a channel capacity comparable to a conventional CDMA system, the polarization separation between two systems doubles the total channel capacity.

The capacity increase can be illustrated from two different angles: cell size expansion or noise reduction:

Cell Size Expansion

In a cellular system the power level is set to a suitable level to guard the intercell interference. (Typically, a different frequency band is used in an adjacent cell. The power level is restricted such that a frequency band can be re-used the cell next to the adjacent cell.)

If an alternative polarization is used in the adjacent cell, with a 30 dB polarization, the same frequency band can be re-used.

Thus, given that same bandwidth the introduction of polarization can expand the coverage from π r² to π (2r)² or π (3r)². Conservatively, it can cover 4 times as much area.

If a larger area is not the goal, the advantage can be converted into 4 times less of the required bandwidth or 4 times as much of the data rate.

The above discussion can also be considered from the power of view. One can boost the power level π (2r)² times, without causing interference to the adjacent cell. The ability to output at the higher level of power lead to the increase in communication capacity.

Note that with adjacent cells in different polarizations, a handset must have an antenna front-end of receiving signals in both polarizations. The determination of which to use can be incorporated into the lead training sequence in a typical cellular signal form. The depolarization effects due to propagation path, or simply due to the change orientation of user, can also be countered during the training sequence period.

Noise Reduction In PDMA, non-intended stations appear as noise. This pseudo noise limits the overall capacity. The basic channel capacity C can be written as:

C=W log₂(1+P/N)

where W is the bandwidth, P is the signal power and N is the noise level.

In the PDMA, by average, half of the signals will propagate in one polarization and the other half the opposite polarization.

Comparing to a non-polarization system, the noise level in each polarization will be half, for effectively having only half of the users in one polarization at a given time. Thus the noise term N in the above equation will be cut in half:

Cᵥ=W log₂(1+P/N/2)

Cₙ=W log (1+P/N/2)

So for each of two orthogonal polarizations the channel capacity is doubled from both channels, the total capacity increase will be 4 times.

The invention according to the application presents a novel multiplex technique referred to as PDMA. Summarizing, some of its major advantages and killer applications are given below.

In channel multiplexing, the attribute of wave polarization has not been utilized. A company that utilizes the PDMA will gain an extra dimension in relation to competitors, in terms of providing a higher data rate and clarity. In addition, the method is: scalable for frequency independence, compatible to the existing methods, and easy to implement requiring no esoteric devices or astronomical amount of processing resources.

However the possible effects of depolarization over rough environments may need considerations for the mobile receiver's orientation.

Advantageous Applications:

1. High Speed Data Link for Fixed Sites

Fixed sites can best utilize the PDMA. The fixed site links often cover the highly valued customers, namely small and medium businesses. They are too small for a dedicated fiber line yet too big for a low speed wire link.

2. Metropolitian Base Station Reduction

The metropolitan areas, having a large number of wireless users, require an increasing number of substations. The PDMA being able to provide extra capacity reduces the number of stations required.

3. Enhanced Secure Communications

The polarization provides another dimension of security. The signal of different polarizations will not register in a single conventional receiver. A snooper would need two receivers to cover both polarizations and synchronize the sequences. The extra complexity to intercept and decode provides enhancement for secure communications.

Although the invention has been described above in connection with particular detailed embodiments, it will be understood that other embodiments and designs are possible, as the scope of the invention will be defined by the patent claims. For example, more than two levels or values of polarization may be utilized, e-g- three, four or more, and the polarizations need not be mutually orthogonal. Other variations will also be possible.

1. A method of wireless communication comprising at least one communication channel whereupon a multiplex technique is employed for the communication, whereby a multiplexing technique using wave polarization (PDMA—Polarization Division Multiplex Access) is utilized and whereby a signal transmitted on said at least one communication channel is subjected to a polarization sequence.

2. Method according to claim 1, characterized in that a polarization using at least two different polarization values is utilized.

3. Method according to claim 2, characterized in that said at least two different polarization values are substantially orthogonal.

4. Method according to claim 2 or 3, characterized in that said at least two polarization values are a substantially left-hand-circular polarization and a substantially right-hand-circular polarization.

5. Method according to claim 2 or 3, characterized in that said at least two polarization values are a substantially vertical polarization and a substantially horizontal polarization.

6. Method according to one or more of claims 1-5, characterized in that said polarization sequence corresponds to a sequence code.

7. System for wireless communication comprising at least one communication channel whereupon a multiplex technique is employed for the communication, wherein said system comprises means for transmitting and/or receiving wireless communication signals, said signals having at least two different values of polarization and wherein the system comprises means for introducing a polarization sequence to a signal to be transmitted, preferably in the form of a sequence code, and/or for depolarizing a received signal.

8. System according to claim 7, characterized in that said at least two different polarization values are substantially orthogonal.

9. System according to claim 7 or 8, characterized in that said at least two different polarization values are a substantially left-hand-circular polarization and a substantially right-hand-circular polarization.

10. System according to claim 7 or 8, characterized in that said at least two different polarization values are a substantially vertical polarization and a substantially horizontal polarization.

11. System according to one or more of claims 7-10, characterized in that the system comprises antenna and/or waveguide means for transmitting and/or receiving communication signals, said means being capable of transmitting and/or receiving communication signals with at least two different values of polarization.

12. Transmitter for use in connection with method according to one or more of claims 1-6 and/or in connection with system according to one or more of claims 7-11, wherein said transmitter comprise at least two antenna and/or waveguide means for transmitting signals with at least two different values of polarization.

13. Transmitter according to claim 12, characterized in that the transmitter comprises coding means for introducing a coding sequence to an input signal to be transmitted.

14. Receiver for use in connection with method according to one or more of claims 1-6 and/or in connection with system according to one or more of claims 7-11, wherein said receiver comprise at least two antenna and/or waveguide means for receiving signals with at least two different values of polarization.

15. Receiver according to claim 14, characterized in that the receiver comprises decoding means for decoding a received signal in accordance with a coding sequence.

16. Use of method according to one or more of claims 1-6 in connection with cellular communication systems.

17. Use of system according to one or more of claims 7-11 in connection with cellular communication systems.

18. Use of transmitter according to claim 12 or 13 in connection with cellular communication systems.

19. Use of receiver according to claim 14 or 15 in connection with cellular communication systems.

20. Use of method according to one or more of claims 1-6 in connection with secure communication systems.

21. Use of system according to one or more of claims 7-11 in connection with secure communication systems.

22. Use of transmitter according to claim 12 or 13 in connection with secure communication systems.

23. Use of receiver according to claim 14 or 15 in connection with secure communication systems.
